(19) United States
(12) Patent Application Publication
(10) Pub. No.: US 2010/0061279 A1
(43) Pub. Date: Mar. 11, 2010

(54) Transmitting and Receiving Wireless Signals Via Dual Antennas

(75) Inventors: Mikael Bergholz Knudsen, Gistrup (DK); Peter Bundgaard, Aalborg (DK)

Correspondence Address: LEE & HAYES, PLLC, 601 W RIVERSIDE AVENUE, SUITE 1400, SPOKANE, WA, 99201, US

(73) Assignee: Infineon Technologies AG, Neubiberg (DE)

(21) Appl. No.: 12/206,567

(22) Filed: Sep. 8, 2008

(51) Int. Cl. H04L 5/14; H04B 1/38

(52) U.S. Cl. 370/278; 455/73

(57) ABSTRACT

Systems, methods, and devices to transmit and receive wireless signals are described.

### BACKGROUND

The demand to communicate larger amounts of data wirelessly at faster rates continues to increase. Wireless communication devices, such as smart phones, mobile telephones, laptop computers, and hand-help computing devices (e.g. personal digital assistants (PDAs)), allow users to transmit and receive data via wireless signals at high rates. Transmitting and receiving wireless signals at high data rates requires higher signal quality at the wireless communication device.

In wireless communication devices that include dual antennas, the antenna providing the best performance may vary. For example, fading and user interaction, such as a user inadvertently covering an antenna with a hand or finger, may affect received signal quality at a particular antenna. Signal quality may be increased by adding a second receiver chain.

A wireless communication device including dual antennas may determine the best antenna for transmitting wireless signals based on the quality of signals received via each respective antenna. A switch, such as a single throw two pole switch, may be inserted in transmission paths and receiving paths to allow switching between the different transmission paths and receiving paths to optimize performance. To illustrate, the wireless communication device may switch between receiving signals via the first antenna and receiving signals via the second antenna to identify the antenna providing the best received signal quality at a given time. The insertion loss related to the switch may degrade signal quality at the wireless communication device.

### BRIEF DESCRIPTION OF THE DRAWINGS

The detailed description is described with reference to the accompanying figures. In the figures, the left most digit(s) of a reference number identifies the figure in which the reference number first appears. The use of the same reference numbers in different figures indicates similar or identical items.

FIG. 1 shows an exemplary system to transmit and receive wireless signals via dual antennas.

FIG. 2 shows a schematic circuit diagram of a first embodiment of an exemplary architecture to transmit and receive wireless signals via dual antennas.

FIG. 3 shows a schematic circuit diagram of a second embodiment of an exemplary architecture to transmit and receive wireless signals via dual antennas.

FIG. 4 shows a schematic circuit diagram of a third embodiment of an exemplary architecture to transmit and receive wireless signals via dual antennas.

FIG. 5 shows a schematic circuit diagram of a fourth embodiment of an exemplary architecture to transmit and receive wireless signals via dual antennas.

FIG. 6 shows a flowchart of a first embodiment of a method to transmit and receive wireless signals via dual antennas.

FIG. 7 shows a flowchart of a second embodiment of a method to transmit and receive wireless signals via dual antennas.

### DETAILED DESCRIPTION

The disclosure is directed to transmitting and receiving wireless signals via dual antennas. The transmission and reception are achieved using techniques to minimize insertion loss, thereby lessening any signal degradation. At least one implementation described herein includes a transceiver to transmit and receive wireless signals via dual antennas. The transceiver generates a first transmission signal and a second transmission signal that is phase shifted with respect to the first transmission signal. The transceiver also sends the first transmission signal and the second transmission signal to a power amplifier module. The first transmission signal and the second transmission signal may be sent to an external device, such as a base station, via a first antenna and a second antenna coupled to the power amplifier module.

According to another implementation described herein, a system to transmit and receive wireless signals includes a transceiver and a power amplifier module coupled to the transceiver. The power amplifier module includes a hybrid circuit and a plurality of power amplifier units. A transmission signal received at the power amplifier module is split into a first portion and a second portion by the hybrid circuit. The first portion of the transmission signal is sent from the hybrid circuit to a first power amplifier unit and the second portion of the transmission signal is sent from the hybrid circuit to a second power amplifier unit. The first power amplifier unit forwards the first portion of the transmission signal to a first antenna via a first duplex filter and the second power amplifier unit forwards the second portion of the transmission signal to a second antenna via a second duplex filter. Splitting the transmission signal into a first portion and a second portion reduces the load on the first duplex filter and the second duplex filter.

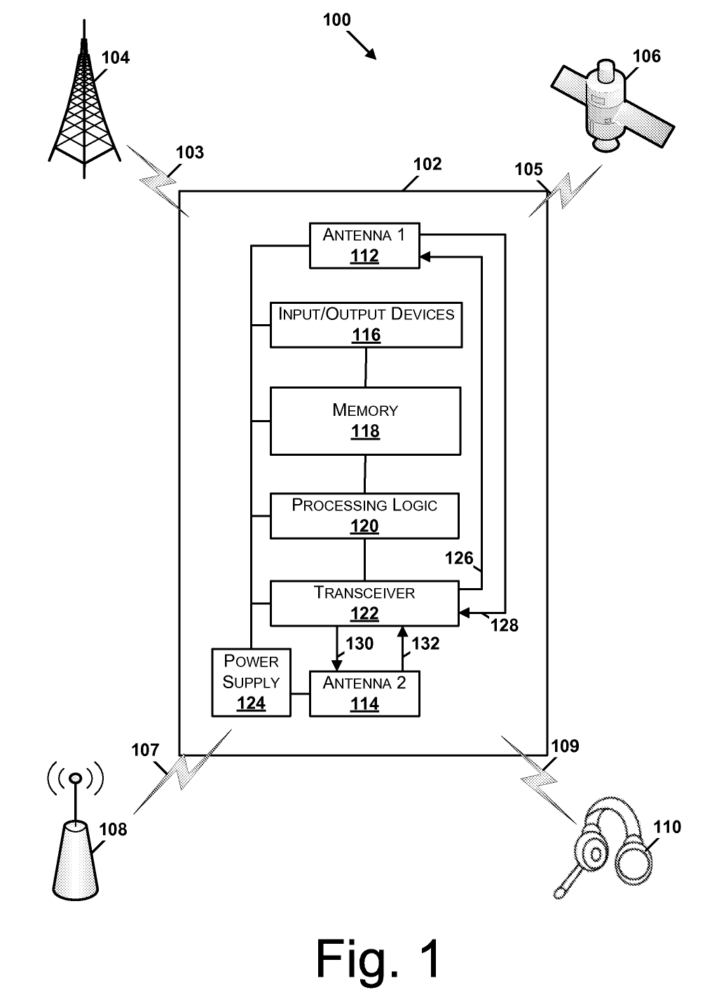

FIG. 1 shows an embodiment of a system 100 to transmit and receive wireless signals via dual antennas. The system 100 includes a wireless communication device 102 that is configured to transmit wireless signals to, and receive wireless signals from, one or more external devices. The wireless signals may include voice traffic, data, control information, or any combination thereof. The wireless communication device 102 may be implemented in any number of ways, including as a smart phone, a hand-held computing device (e.g., a personal digital assistant (PDA)), a mobile telephone, a media playing device, a portable gaming device, a personal computer, a laptop computer, another suitable wireless communication device, or any combination thereof.

In one embodiment, the wireless communication device 102 may transmit and/or receive wireless signals 103 via a base station 104. The base station 104 may be included in a wide area wireless communication network, such as a global system for mobile communications (GSM) network, a universal mobile telecommunications system (UMTS) network, a code division multiple access (CDMA) network, a high speed packet access (HSPA) network, a general packet radio service (GPRS) network, an enhanced data rates for GSM evolution (EDGE) network, a worldwide interoperability for microwave access (WiMAX) network, or any combination thereof.

In another embodiment, the wireless communication device 102 may transmit and/or receive wireless signals 105 via a communication satellite 106. Further, the wireless communication device 102 may transmit and/or receive wireless signals 107 via a wireless access point 108. The wireless access point 108 may be included in a wide area wireless network or a wireless local area network, such as a Bluetooth network or an Institute of Electrical and Electronics Engineers (IEEE) 802.11 protocol network. Additionally, the wireless communication device 102 may transmit and/or receive wireless signals 109 via a headset 110, such as a Bluetooth headset.

In a particular embodiment, the wireless communication device 102 includes a first antenna 112 and a second antenna 114. The first antenna 112 and the second antenna 114 may be placed in various locations of the wireless communication device 112. For example, the first antenna 112 may be placed at a bottom portion of the wireless communication device 102 and the second antenna 114 may be placed at a top portion of the wireless communication device 102. The wireless communication device also includes one or more input/output devices 116. In an illustrative embodiment, the input/output devices 116 may include a microphone, a speaker, a touchpad display, a cursor control device, such as a mouse, a keypad, or any combination thereof.

The wireless communication device 102 also includes memory 118 and processing logic 120. The memory 118 may include random access memory (RAM), flash memory, a hard disk, or any combination thereof. Additionally, the memory 118 may store one or more applications configured to transmit and/or receive wireless signals. For example, the memory 118 may store an application configured to send and receive wireless signals related to telephone calls, such as voice traffic or control information. In another example, the memory 118 may store an application configured to request and receive website data, an application configured to transmit and receive text messages, an application configured to transmit and receive picture messages, an application configured to transmit and receive video messages, or any combination thereof. The applications stored in the memory 118 may include software instructions, hardware, or any combination thereof.

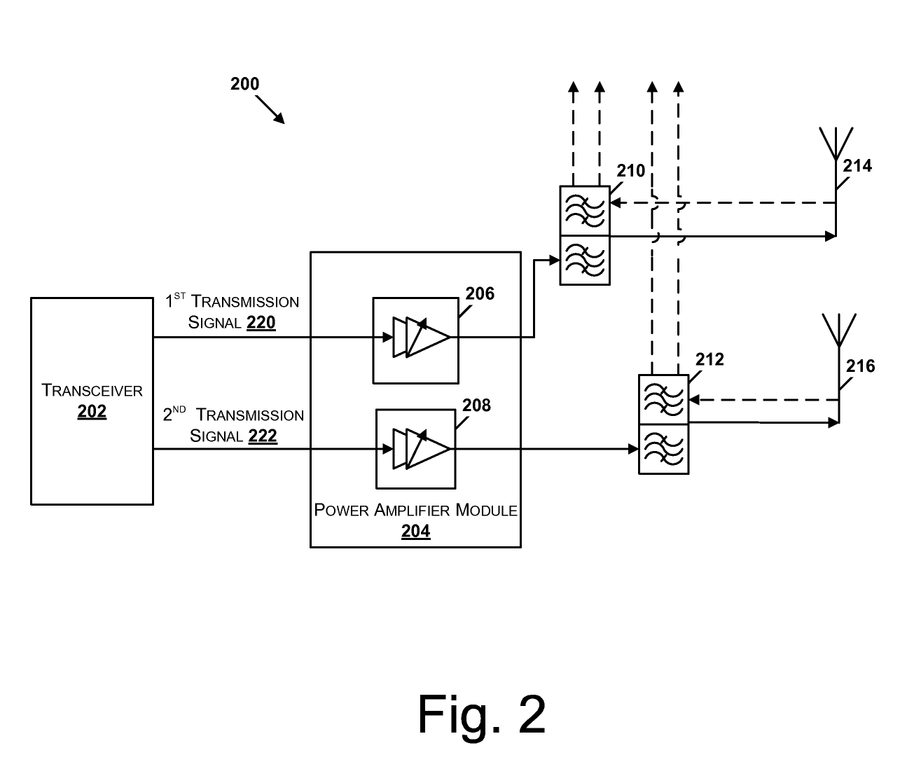

In addition, the wireless communication device 102 includes a transceiver 122 and a power supply 124, such as a battery. The transceiver 122 is configured to utilize a first transmission path 126 to transmit wireless signals to the one or more external devices 104, 106, 108, and 110. Further, the transceiver 122 is configured to utilize a first receiving path 128 to receive wireless signals from the one or more external devices 104, 106, 108, and 110. The transceiver 122 is also configured to utilize a second transmission path 130 to transmit wireless signals to the one or more external devices 104, 106, 108, and 110 and to utilize a second receiving path 132 to receive wireless signals from the one or more external devices 104, 106, 108, and 110. The first transmission path 126, the first receiving path 128, the second transmission path 130, and the second receiving path 132 may also include other devices, such as filters, amplifiers, switches, hybrid circuits, or any combination thereof. Examples of transmission paths and receiving paths are illustrated in FIGS. 2-5.

In an illustrative embodiment, the transceiver 122 generates a first transmission signal and a second transmission signal after receiving information from an application stored in the memory 118. The second transmission signal is phase shifted with respect to the first transmission signal. The first transmission signal may be forwarded along the first transmission path 126 and sent to one or more of the external devices 104, 106, 108, and 110 via the first antenna 112. Additionally, the second transmission signal may be forwarded along the second transmission path 130 and sent to one or more of the external devices 104, 106, 108, and 110 via the second antenna 114.

In another illustrative embodiment, the transceiver 122 generates a single transmission signal after receiving information from an application stored in the memory 118 and the single transmission signal is split into a first portion and a second portion by a hybrid circuit of a power amplifier module (not shown) coupled to the transceiver 122. The first portion of the transmission signal may be forwarded along the first transmission path 126 and sent to one or more of the external devices 104, 106, 108, and 110 via the first antenna 112. Further, the second portion of the transmission signal may be forwarded along the second transmission path 130 and sent to one or more of the external devices 104, 106, 108, and 110 via the second antenna 114.

FIG. 2 shows a first embodiment of architecture 200 to transmit and receive wireless signals via dual antennas. The architecture 200 may be included in the wireless communication device 102 shown in FIG. 1. The architecture 200 includes a transceiver 202 coupled to a power amplifier module 204. The power amplifier module 204 includes a plurality of power amplifier units, such as a first power amplifier unit 206 and a second power amplifier unit 208. The first power amplifier unit 206 is coupled to a first duplex filter 210 via a first output port of the power amplifier module 204 and an input port of the first duplex filter 210. The second power amplifier unit 208 is coupled to a second duplex filter 212 via a second output port of the power amplifier module 204 and an input port of the second duplex filter 212. The first duplex filter 210 is coupled to a first antenna 214 and the second duplex filter 212 is coupled to a second antenna 214.

The transceiver 202 is configured to transmit wireless signals via one or more transmission paths. The wireless signals may be related to voice traffic, data, control information, or any combination thereof. In a particular embodiment, a first transmission path includes at least the transceiver 202, the first power amplifier unit 206, the first duplex filter 210, and the first antenna 214 and a second transmission path includes at least the transceiver 202, the second power amplifier unit 208, the second duplex filter 212, and the second antenna 216. Portions of the first transmission path and the second transmission path are shown by solid lines with arrows in FIG. 2.

In a particular embodiment, the transceiver 202 may receive information via an application or another component of a wireless communication device and transmit the information to an external device, such as a base station or wireless access point, via each of the antennas 214, 216. For example, the transceiver 202 may receive website data from a web browser application to transmit to a particular external device. In another example, the transceiver 202 may receive voice traffic from an analog to digital converter device to transmit to an external device.

In an illustrative embodiment, the transceiver 202 includes logic that is configured to generate a first transmission signal 220 and a second transmission signal 222 from the received information. The transceiver 202 also include logic that is configured to transmit the first transmission signal 220 via the first transmission path and transmit the second transmission signal 222 via the second transmission path. For example, the transceiver 202 may send the first transmission signal 220 to the first power amplifier unit 206 and the first power amplifier unit 206 may forward the first transmission signal 220 to the second antenna 214 via the first duplex filter 210. Additionally, the transceiver 202 may send the second transmission signal 222 to the second power amplifier unit 208 and forward the second transmission signal 222 to the second antenna 216 via the second duplex filter 212. The routing of the transmission signals via both the first duplex filter 210 and the second duplex filter 212 reduces the load on each of the duplex filters 210, 212.

The transceiver 202 may digitally phase shift the second transmission signal 222 with respect to the first transmission signal 220. For example, the second transmission signal 222 may be phase shifted with respect to the first transmission signal 220 by 90 degrees. In an illustrative, non-limiting embodiment, the transceiver 202 may be configured to transmit the first transmission signal 220 and the second transmission signal 222 to a base station of a wide area wireless network and the second transmission signal 220 may be phase shifted with respect to the first transmission signal 220 such that the base station receives the signals in phase. Additionally, a power level of the first transmission signal 220 and a power level of the second transmission signal 222 may be adjusted independently by the first power amplifier unit 206 and the second power amplifier unit 208, respectively. Adjustment of both the phase and power level of the first transmission signal 220 and the second transmission signal 222 provides an opportunity for maximal ratio combining at the base station.

The architecture 200 may also be configured to receive signals via the first antenna 214 and the second antenna 216. The architecture 200 may have a first receiving path that includes at least the first antenna 214, the first duplex filter 210, and the transceiver 202, and a second receiving path that includes the second antenna 216, the second duplex filter 212, and the transceiver 202. Portions of the first receiving path and the second receiving path are shown by dashed lines in FIG. 2. The first duplex filter 210 and the second duplex filter 212 allow transmission signals to pass from the power amplifier module 204 to the antennas 214, 216 and allow received signals to pass from the antennas 214, 216 to the transceiver 202 via the power amplifier module 204.

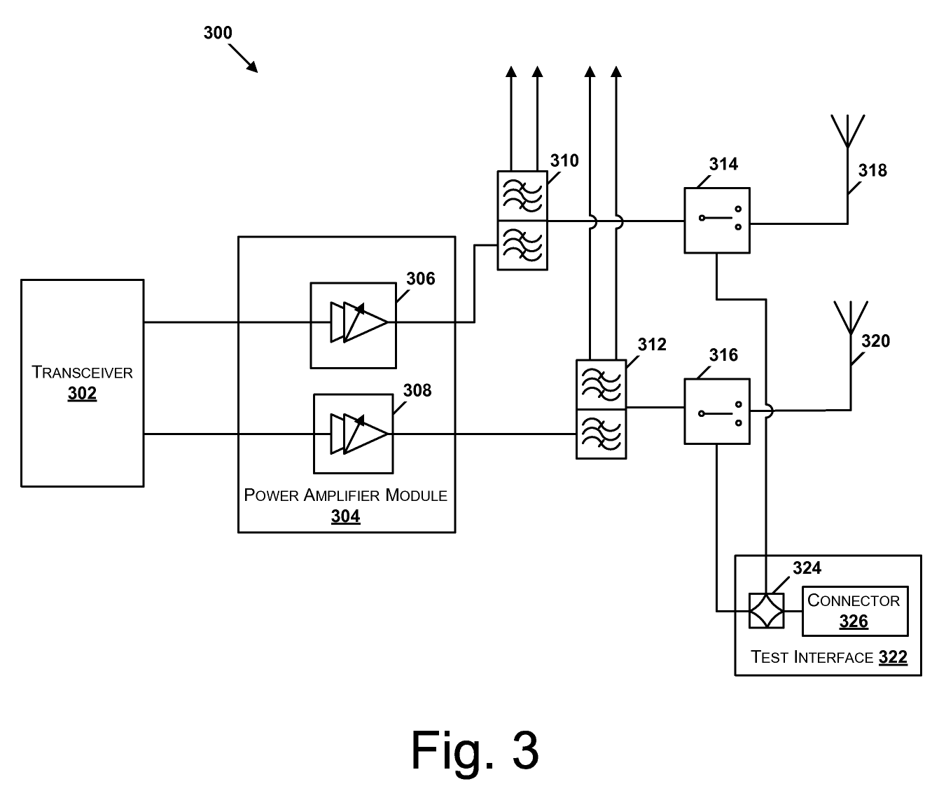

FIG. 3 shows a second embodiment of architecture 300 to transmit and receive wireless signals via dual antennas. The architecture 300 may be included in the wireless communication device 102 shown in FIG. 1. The architecture 300 includes a transceiver 302 coupled to a power amplifier module 304. The power amplifier module 304 includes a plurality of power amplifier units, such as a first power amplifier unit 306 and a second power amplifier unit 308. The first power amplifier unit 306 is coupled to a first duplex filter 310 and the second power amplifier unit 308 is coupled to a second duplex filter 312. The first duplex filter 310 is coupled to a first mechanical test connector 314 and the second duplex filter 312 is coupled to a second mechanical test connector 316. The first mechanical test connector 314 and the second mechanical test connector 316 may include a switch, such as a single pole two throw (SP2T) switch. The first mechanical test connector 314 is coupled to a first antenna 318 and the second mechanical test connector 316 is coupled to a second antenna 320. Additionally, the first mechanical test connector 314 and the second mechanical test connector 316 are coupled to a test interface 322. The test interface 322 includes a hybrid circuit 324 and a connector 326.

In an illustrative embodiment, the connector 326 may be coupled to testing equipment (not shown). The testing equipment may be configured to test the quality of signals received and transmitted via the architecture 300. In one example, the transceiver 302 may transmit a first transmission signal to the first power amplifier unit 306 and a second transmission signal to the second power amplifier unit 308. The second transmission signal may be phase shifted with respect to the first transmission signal. The first power amplifier unit 306 may adjust the power level of the first transmission signal and forward the first transmission signal to the first mechanical test connector 314 via the first duplex filter 310. Further, the second power amplifier unit 308 may adjust the power level of the second transmission signal and forward the second transmission signal to the second mechanical test connector 316 via the second duplex filter 308.

The first mechanical test connector 314 may be configured to forward the first transmission signal to the test interface 322 or to the first antenna 318. Additionally, the second mechanical test connector 316 may be configured to forward the second transmission signal to the test interface 322 or to the second antenna 320. The hybrid circuit 324 of the test interface 322 may receive the first transmission signal, the second transmission signal, or any combination thereof, and forward the first transmission signal, the second transmission signal, or the combined signal to the testing equipment to evaluate the quality of the particular signal.

Further, the testing equipment may test the quality of a signal received at the transceiver 302. To illustrate, the testing equipment may send a test signal to the test interface 322 and the hybrid circuit 324 of the test interface 322 may split the test signal into a first portion and a second portion. The first portion of the test signal may be sent to the first mechanical test connector 314 and the second portion of the test signal may be sent to the second mechanical test connector 316. The first mechanical test connector 314 may forward the first portion of the test signal to the transceiver 302 via the first duplex filter 310 and the second mechanical test connector 316 may forward the second portion of the test signal to the transceiver 302 via the second duplex filter 312.

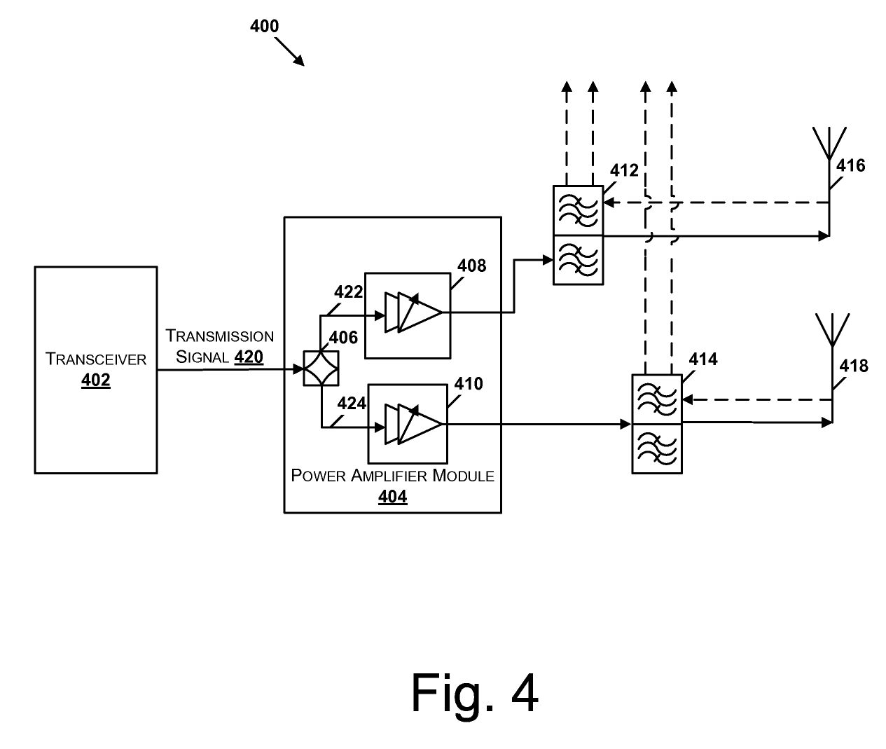

FIG. 4 shows a third embodiment of architecture 400 to transmit and receive wireless signals via dual antennas. The architecture 400 may be included in the wireless communication device 102 shown in FIG. 1. The architecture 400 includes a transceiver 402 coupled to a power amplifier module 404. The power amplifier module 404 includes a hybrid circuit 406 and a plurality of power amplifier units, such as a first power amplifier unit 408 and a second power amplifier unit 410. The hybrid circuit 406 may include a silicon on insulator semiconductor device.

The hybrid circuit 406 is coupled to an input port of the power amplifier module 404. Additionally, a first output port of the hybrid circuit 406 is coupled to the first power amplifier unit 408 and a second output port of the hybrid circuit 406 is coupled to the second power amplifier unit 410. The first power amplifier unit 408 is coupled to a first duplex filter 412 via a first output port of the power amplifier module 404 and an input port of the first duplex filter 412. The second power amplifier unit 410 is coupled to a second duplex filter 414 via a second output port of the power amplifier module 404 and an input port of the second duplex filter 414. The first duplex filter 412 is coupled to a first antenna 416 and the second duplex filter 414 is coupled to a second antenna 418.

The transceiver 402 is configured to transmit wireless signals via one or more transmission paths. The wireless signals may be related to voice traffic, data, control information, or any combination thereof. In a particular embodiment, a first transmission path includes at least the transceiver 402, the hybrid circuit 406, the first power amplifier unit 408, the first duplex filter 412, and the first antenna 416, and a second transmission path includes at least the transceiver 402, the hybrid circuit 406, the second power amplifier unit 410, the second duplex filter 414, and the second antenna 418. Portions of the first transmission path and the second transmission path are shown by solid lines with arrows in FIG. 4.

In a particular embodiment, the transceiver 402 may receive information via an application or another component of a wireless communication device and transmit the information to an external device, such as a base station or wireless access point, via each of the antennas 416, 418. In an illustrative embodiment, the transceiver 402 includes logic configured to generate a transmission signal 420 from the received information and sends the transmission signal 420 to the power amplifier module 404. The hybrid circuit 406 of the power amplifier module 404 splits the transmission signal 420 into a first portion 422 and a second portion 424. A power level of the first portion of the transmission signal 422 may be adjusted by the first power amplifier unit 408 and the first portion of the transmission signal 422 may then be sent to the first antenna 416 via the first duplex filter 412. Additionally, a power level of the second portion of the transmission signal 424 may be adjusted by the second power amplifier unit 410 and the second portion of the transmission signal 422 may then be sent to the second antenna 418 via the second duplex filter 414.

The architecture 400 may also be configured to receive signals via the first antenna 416 and the second antenna 418. The architecture 400 may have a first receiving path that includes at least the first antenna 416, the first duplex filter 412, and the transceiver 402, and a second receiving path that includes at least the second antenna 418, the second duplex filter 414, and the transceiver 402. Portions of the first receiving path and the second receiving path are shown by dashed lines in FIG. 4.

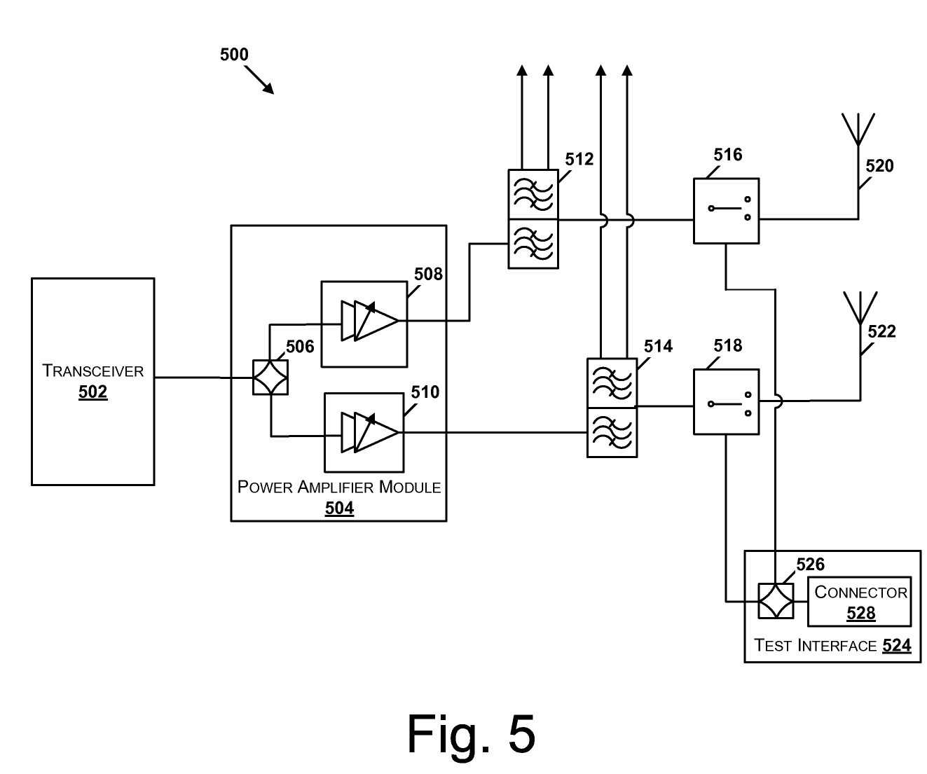

FIG. 5 shows a fourth embodiment of architecture 500 to transit and receive wireless signals via dual antennas. The architecture 500 may be included in the wireless communication device 102 shown in FIG. 1. The architecture 500 includes a transceiver 502 coupled to a power amplifier module 504. The power amplifier module 504 includes a hybrid circuit 506 and a plurality of power amplifier units, such as a first power amplifier unit 508 and a second power amplifier unit 510. The first power amplifier unit 508 is coupled to a first duplex filter 512 and the second power amplifier unit 510 is coupled to a second duplex filter 514. The first duplex filter 512 is coupled to a first mechanical test connector 516 and the second duplex filter 514 is coupled to a second mechanical test connector 518. The first mechanical test connector 516 and the second mechanical test connector 518 may include a switch, such as a single pole two throw (SP2T) switch. The first mechanical test connector 516 is coupled to a first antenna 520 and the second mechanical test connector 518 is coupled to a second antenna 522. Additionally, the first mechanical test connector 516 and the second mechanical test connector 518 are coupled to a test interface 524. The test interface 524 includes a hybrid circuit 526 and a connector 528. The hybrid circuit 526 of the test interface 524 and the hybrid circuit 506 of the power amplifier module 504 may include semiconductor devices with the same structure or semiconductor devices with a different structure.

In an illustrative embodiment, the connector 528 may be coupled to testing equipment (not shown). The testing equipment may be configured to test the quality of signals received and transmitted via the architecture 500. In one example, the transceiver 502 may transmit a transmission signal to the power amplifier module 504. The hybrid circuit 506 of the power amplifier module 504 splits the transmission signal into a first portion that is sent to the first power amplifier unit 508 and a second portion that is sent to the second power amplifier unit 510. The first power amplifier unit 508 may adjust the power level of the first portion of the transmission signal and forward the first portion of the transmission signal to the first mechanical test connector 516 via the first duplex filter 512. Further, the second power amplifier unit 510 may adjust the power level of the second portion of the transmission signal and forward the second portion of the transmission signal to the second mechanical test connector 518 via the second duplex filter 510.

The first mechanical test connector 516 may be configured to forward the first portion of the transmission signal to the test interface 524 or to the first antenna 520. Additionally, the second mechanical test connector 518 may be configured to forward the second portion of the transmission signal to the test interface 524 or to the second antenna 522. The hybrid circuit 526 of the test interface 524 may receive the first portion of the transmission signal, the second portion of the transmission signal, or any combination thereof, and forward the first test signal, the second test signal, or the combined signal to the testing equipment to evaluate the quality of the particular signal.

Further, the testing equipment may test the quality of a signal received at the transceiver 502. To illustrate, the testing equipment may send a test signal to the test interface 524 and the hybrid circuit 526 of the test interface 524 may split the test signal into a first portion and a second portion. The first portion of the test signal may be sent to the first mechanical test connector 516 and the second portion of the test signal may be sent to the second mechanical test connector 518. The first mechanical test connector 516 may forward the first portion of the test signal to the transceiver 502 via the first duplex filter 512 and the second mechanical test connector 518 may forward the second portion of the test signal to the transceiver 502 via the second duplex filter 514.

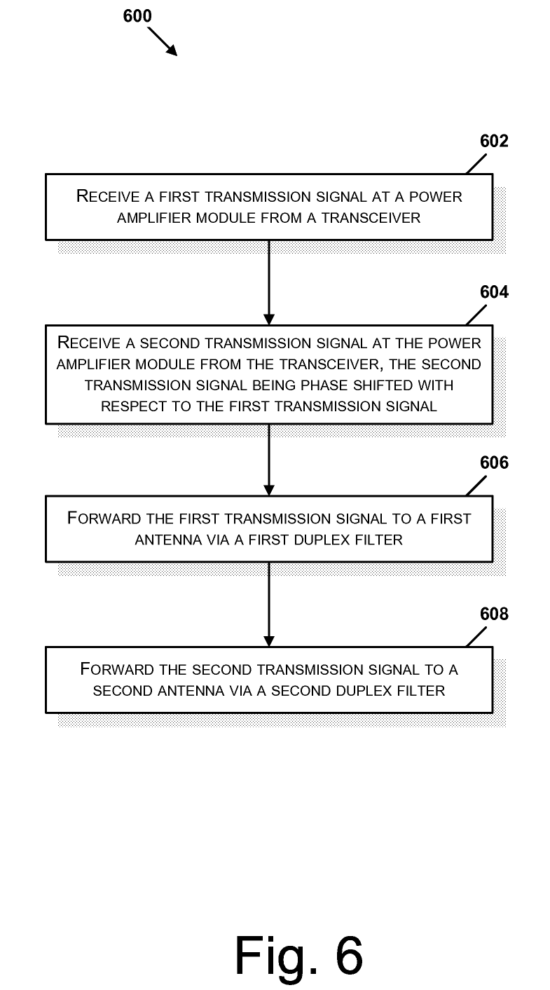

FIG. 6 shows a flowchart of a first embodiment of a method 600 to transmit and receive wireless signals via dual antennas. The method 600 may be implemented utilizing the system shown in FIG. 1 and the architectures shown in FIGS. 2 and 3.

At 602, the method 600 includes receiving a first transmission signal at a power amplifier module from a transceiver. Moving to 604, the power amplifier module receives a second transmission signal from the transceiver. The second transmission signal is digitally phase shifted with respect to the first transmission signal by the transceiver. Additionally, the first transmission signal and the second transmission signal are generated by the transceiver from information received at the transceiver. The information may include voice traffic and control information related to telephone calls, data related to a text message, picture message, or video message, data related to an email, or data related to the Internet. Further, the power amplifier module may include a plurality of power amplifier units. For example, the power amplifier module may include a first power amplifier unit to adjust a power level of the first transmission signal and a second power amplifier unit to adjust a power level of the second transmission signal.

The method 600 also includes at 606, forwarding the first transmission signal from the power amplifier module to a first antenna via a first duplex filter. Proceeding to 608, the second transmission signal is forwarded from the power amplifier module to a second antenna via a second duplex filter. In an illustrative embodiment, the first transmission signal and the second transmission signal are sent to an external device, such as a base station, via the first antenna and the second antenna. The first transmission signal and the second transmission signal may be phase shifted and may have power levels adjusted such that maximal signal combining is provided at the base station.

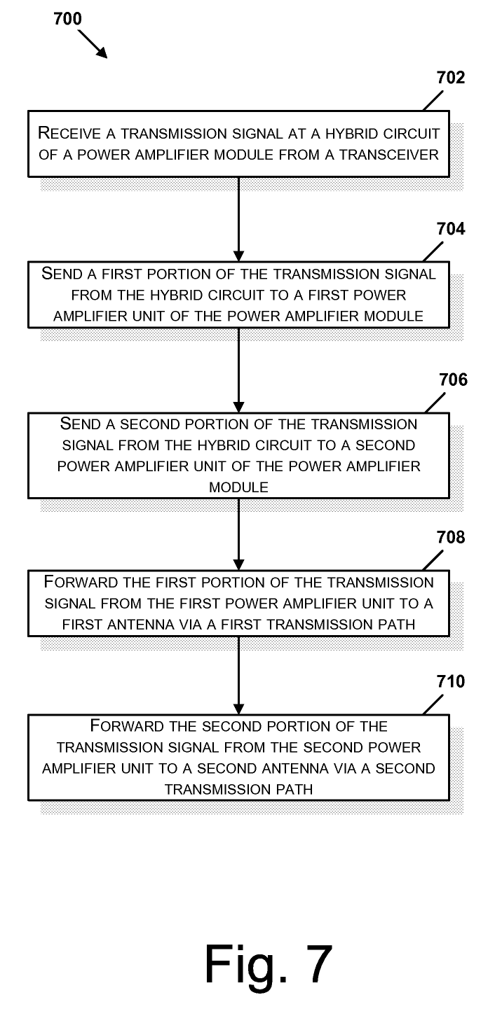

FIG. 7 shows a flowchart of a second embodiment of a method 700 to transmit and receive wireless signals via dual antennas. The method 700 may be implemented utilizing a system shown in FIG. 1 and the architectures shown in FIGS. 4 and 5.

At 702, the method 700 includes receiving a transmission signal at a hybrid circuit of a power amplifier module from a transceiver. Moving to 704, a first portion of the transmission signal is sent from the hybrid circuit to a first power amplifier unit of the power amplifier module. Advancing to 706, a second portion of the transmission signal is sent from the hybrid circuit to a second power amplifier unit of the power amplifier module.

At 708, the method 700 includes forwarding the first portion of the transmission signal from the first power amplifier unit to a first antenna via a first transmission path. The first transmission path may include a number of components, including a first duplex filter. Proceeding to 710, a second portion of the transmission signal is forwarded from the second power amplifier unit to a second antenna via a second transmission path. The second transmission path may also include a number of components, including a second duplex filter.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A transceiver comprising:
logic configured to:
generate a first transmission signal;
generate a second transmission signal that is phase shifted with respect to the first transmission signal;
send the first transmission signal to a power amplifier module; and
send the second transmission signal to the power amplifier module.

2. The transceiver of claim 1, wherein the first transmission signal and the second transmission signal are generated based on data received at the transceiver from a software application.

3. The transceiver of claim 1, wherein the first transmission signal and the second transmission signal are generated based on voice traffic received at the transceiver.

4. The transceiver of claim 1, wherein the second transmission signal is phase shifted with respect to the first transmission signal by 90 degrees.

5. The transceiver of claim 1, wherein the logic is configured to send the first transmission signal and the second transmission signal to a test interface via one or more mechanical test connectors.

6. The transceiver of claim 5, wherein the test interface comprises a hybrid circuit configured to receive the first transmission signal and the second transmission signal.

7. The transceiver of claim 5, wherein the one or more mechanical test connectors comprise a single pole two throw switch.

8. A system comprising:
a transceiver;
a power amplifier module coupled to the transceiver, the power amplifier module comprising:
a hybrid circuit coupled to an input port of the power amplifier module;
a first power amplifier unit coupled to a first output port of the hybrid circuit;
a second power amplifier unit coupled to a second output port of the hybrid circuit;
a first duplex filter coupled to a first output port of the power amplifier module;
a second duplex filter coupled to a second output port of the power amplifier module;
a first antenna coupled to the first duplex filter; and
a second antenna coupled to the second duplex filter.

9. The system of claim 8, further comprising:
processing logic; and
memory accessible to the processing logic, the memory comprising instructions executable by the processing logic to transmit at least one of data, voice traffic, and control information via a wide area wireless network, a satellite network, a wireless local area network, or any combination thereof.

10. The system of claim 9, wherein the wide area wireless network comprises a global system for mobile communications (GSM) network, a general packet radio service (GPRS) network, an enhanced data rates for GSM evolution (EDGE) network, a universal mobile telecommunications system (UMTS) network, a high speed packet access (HSPA) network, or a worldwide interoperability for microwave access (WiMAX) network.

11. The system of claim 9, wherein the wireless local area network comprises a Bluetooth network or an Institute of Electrical and Electronics Engineers (IEEE) 802.11 protocol network.

12. The system of claim 8, further comprising a power supply, one or more input devices, one or more output devices, or any combination thereof.

13. The system of claim 8, wherein the transceiver is configured to send a transmission signal to the power amplifier module.

14. The system of claim 13, wherein the hybrid circuit is configured to receive the transmission signal and forward a first portion of the transmission signal to the first power amplifier unit and to forward a second portion of the transmission signal to the second power amplifier unit.

15. The system of claim 14, wherein the first power amplifier unit forwards the first portion of the transmission signal to the first antenna via the first duplex filter and the second power amplifier unit forwards the second portion of the transmission signal to the second antenna via the second duplex filter.

16. A method comprising:
generating a first transmission signal and a second transmission signal at a transceiver, wherein the second transmission signal is phase shifted with respect to the first transmission signal;
forwarding the first transmission signal to a first antenna via a first duplex filter; and
forwarding the second transmission signal to a second antenna via a second duplex filter.

17. The method of claim 16, wherein the transceiver generates the first transmission signal and the second transmission signal from particular information received at the transceiver.

18. The method of claim 16, further comprising:
sending the first transmission signal to a base station via the first antenna; and
sending the second transmission signal to the base station via the second antenna.

19. The method of claim 18, wherein the second transmission signal is phase shifted with respect to the first transmission signal such that the base station receives the first transmission signal and the second transmission signal in phase.

20. The method of claim 17, wherein the first transmission signal is received at a first power amplifier unit of a power amplifier module and the second transmission signal is received at a second power amplifier unit of the power amplifier module, wherein the first power amplifier unit is configured to adjust a power level of the first transmission signal and the second power amplifier unit is configured to adjust a power level of the second transmission signal, and wherein the power level of the first transmission signal and the power level of the second transmission signal are adjusted to provide maximal ratio combining at the base station.
